(19) United States
(12) Patent Application Publication
(10) Pub. No.: US 2011/0004582 A1
(43) Pub. Date: Jan. 6, 2011

(54) METHOD OF CONSTRUCTING THE INTELLIGENT COMPUTER SYSTEMS BASED ON INFORMATION REASONING

(75) Inventor: Guoding HU, Tianjin (CN)

Correspondence Address: SUGHRUE MION, PLLC, 2100 PENNSYLVANIA AVENUE, N.W., SUITE 800, WASHINGTON, DC, 20037, US

(73) Assignee: Nankai University, Tianjin (CN)

(21) Appl. No.: 12/829,926

(22) Filed: Jul. 2, 2010

(30) Foreign Application Priority Data
Jul. 3, 2009 (CN) 200910069544.2

(51) Int. Cl. G06F 17/00

(52) U.S. Cl. 706/59

(57) ABSTRACT

A method of constructing the intelligent computer systems based on information reasoning, the method comprising the steps of: obtaining the problem from the users and analyzing the corresponding user demands; choosing the data relating to the user demands in databases and collecting the external data for solving the problems; preprocessing the data and generating the data tables; computing the field of probability on the basis of data tables; computing the degree of credibility of the information reasoning rule according to the new information theory; outputting the information reasoning rule “if A, then B” and its degree of credibility; storing the results of the discovered information reasoning rules. The intelligent computer systems constructed by this patent can extract information from the large amount of data automatically. The intelligent systems can decide whether A and B are positively related or negatively related to each other according to the degree of credibility of the information reasoning rule “if A, then B”, moreover, the degree of credibility shows the sufficient degree of the evidences in the reasoning. Since the present patent can help the users to obtain valuable information from the large amount of data, this method can be widely used to construct the intelligent systems based on the large amount of data.

### FIELD OF THE INVENTION

This patent belongs to the technical domain of artificial intelligence. This patent gives a method of constructing the intelligent computer systems whose core is information reasoning. This kind of intelligent system can discover the rules in the large amount of data and extract useful information through the rules. The extracted information can be used for further analysis and reasoning so that the intelligent system can help the users to solve their problem.

### BACKGROUND OF THE INVENTION

1. Data mining: The traditional methods of mining the rules in the large amount of data are the association rule mining, the relevance rule mining, Web mining, and so on. A reference on data mining is the book “Data mining: concepts and techniques” (by Jiawei Han and Micheline Kamber).

The main task of data mining is to mine the rules among the data items in the databases. A traditional work is to mine the association rules. It gives the association rules like “if A, then B” satisfying the minimal support and the minimal confidence conditions, where the support of the rule “if A, then B” is the probability of A and B, while the confidence of the rule is the probability of B under the condition A. The support p(A∩B) of the association rule “if A, then B” reflects the usefulness of the rule and the confidence reflects the certainty of the rule. The general process of the association rule mining is to generate the set of the frequent item sets first and to obtain the association rules satisfying the minimal confidence condition from the set of the frequent item sets after then.

A typical example of the association rule mining is market basket analysis. By discovering the association among the items in the basket of a customer, his buying habits are analyzed. The results of market basket analysis can help the shopkeepers to make sales plan. With the rapid growth of data, many people are more interesting of mining the rules in the large amount data in the databases.

One of the shortages of the association rules is that the confidence of a association rule “if A, then B” does not reflects the causal relation between A and B. Therefore, the confidence does not measure the actual strength of implication between A and B. For example, in a shop, 60% affairs contain the computer games, 75% affairs contain the videos, and 40% affairs contain both of them. Let A=the computer games, B=the videos, then the support of the association rule “if A, then B” is 40% and the confidence is approximately 66%. If setting the minimal support 20%, the minimal confidence 60%, then the association rule “if A, then B” will be reported to the users as a strong association rule. However, the possibility of buying videos is 75% which is greater than 66%. From the fact we can see that the computer games and the videos are negatively related to each other. Buying one of them indeed decreases the possibility of buy the another one. From here we see that the confidence does not measure the actual strength of implication between A and B. It may mislead the users in practice.

Another traditional method is to mine the relevance rules. Here the relevance between A and B in the relevance rule “if A, then B” is measured by

$${corr}_{A , B} = \frac{p ( A , B )}{p ( A ) p ( B )} ,$$

whose value is greater than, equal to or less than 1 reflects A is positively related to, independent with or negatively related to B, respectively. However, it is difficult to know the actual strength of implication between A and B from

$${corr}_{A , B} = \frac{p ( A , B )}{p ( A ) p ( B )} .$$

The Chinese patent 03105330.0 “A method of constructing the intelligent decision supporting systems bases on information mining” (filing date: Feb. 23, 2003, licensing date: Apr. 14, 2004) belongs to the domain of Web mining, which gives a method to discover useful and interesting knowledge (including the forms such as concepts, patterns, rules, constraints, and so on) in the set of a large amount nonstructural Web files. The main methods of data mining in the patent 03105330.0 include discovery of the association rule and serial patterns, clustering and classifying, and so on. The main feature of the patent 03105330.0 is that it chooses the suitable method of data mining according to the different Web objects. However, since all methods in that patent are the traditional methods of data mining, the system constructed by the method of that patent cannot overcome the shortages of the traditional methods.
2. Uncertainty reasoning: Uncertainty, which occurs in the cases where the information is not sufficient, is one feature of the intelligent problems. Reasoning is the main part of process of human thinking, where the conclusion is drawn from the known facts. Uncertainty reasoning is to guess the rational conclusion with uncertainty from the uncertain evidences by using insufficient knowledge.

The most common kind of uncertainty is randomness. In mathematics, the typical theory dealing with randomness is the probability theory. One of uncertainty reasoning is probability logic. There are two kinds of probability logic, one is quantitative probability logic, where the probabilities of the propositions can be computed, the typical example of this kind of probability logic is “the Bayesian network”; the other one is qualitative probability logic, where people do not compute the probabilities of the propositions. Another kind of uncertainty is ambiguity. In mathematics, the typical theory dealing with ambiguity is fuzzy mathematics. In expert systems, the Bayesian network and fuzzy mathematics are widely used. There are also a lot of other models of uncertainty reasoning. We do not list them here.

In a lot of expert systems lying in all kinds of applying fields, the methods of uncertain reasoning are widely used. However, in practice, the application of uncertainty reasoning often needs some certain conditions. For example, when constructing the Bayesian network, the events should satisfy the premise of conditional independency; when constructing the fuzzy system, how to determine the membership functions is a problem and there is certain subjectivity when giving the membership functions, and so on.

### SUMMARY OF THE INVENTION

This invention is to overcome the shortages of the traditional techniques. This invention gives a method of constructing the intelligent systems, whose core is information reasoning. The intelligent systems constructed by the method of this invention can discover useful information in the data and use the information to making further analysis and reasoning so that the discovered information reasoning rules can be used to solve the problems of the users.

The main feature of this invention is that it is on the basis of the new information theory and the core of the intelligent systems is information reasoning. The intelligent systems can automatically discover the information reasoning rules and their degrees of credibility. In the new information theory, the degree of relevance between two events A and B may be positive or negative, which reflects the degree of positive relevance or negative relevance between the events A and B. Moreover, the degree of credibility measures the actual strength of the implication from the premise A to the conclusion B. This shows the importance of information reasoning when discovering the rules in the large amount of data.

This patent gives a method of constructing the intelligent computer systems based on information reasoning. The hardware of the intelligent system consists of the central processing unit and the data storage unit of the computer system and the core of the method is information reasoning, where the data storage unit stores the databases relating to information reasoning, the data tables generated by choosing target-related data, the field of probability computed from the data tables, the parameters for information reasoning and the obtained information reasoning rules and their degrees of credibility. FIG. 2 is the flow diagram of the method 200 of constructing the intelligent computer system according to an example of this patent, its concrete steps comprising:

the first step: obtaining the problem to be solved from the users, that is, obtaining the event B;

the second step: analyzing the user demands according the problem; choosing the data relating to the user demands in databases; collecting the external data for solving the problems; producing the target data from the above data;

the third step: choosing the data for the computation interactively by the users; producing the data tables by preprocessing the chosen data and setting the adjustable parameters—the positive and the negative threshold value for the degree of credibility by the users;

the fourth step, computing the field of probability from the data table. More concretely, the frequency of an event can be computed from the data table. When the data are sufficient, the frequency is approximately equal to the probability according to the law of large numbers in probability theory. Thus we get the field of probability by computing the frequencies of the events;

the fifth step, discovering the rules like “if A, then B” from the data tables; computing the degree of credibility of information reasoning rules according to the new information theory; obtaining the information reasoning rules whose degrees of credibility are greater than the positive threshold value or less than the negative threshold value.

the sixth step: storing the information reasoning rules and their degrees of credibility, which are obtained in the fifth step;

the seventh step: showing the information reasoning rules obtained in the fifth step interactively to the users and helping the users to valuate the information.

### THE ADVANTAGES AND EFFECTS OF THIS INVENTION

The intelligent computer systems constructed by this patent can smartly process the information of a large amount of data and automatically extract information in the data. The intelligent systems discover the rules among the large amount of data and represent the rules by the information reasoning rules with their degrees of credibility. The degree of credibility of the rule A→B reflects not only the positive or negative relevance between A and B, but also the actual strength of implication from the evidence A to the result B in the rule A→B. Therefore, the degree of credibility quantitatively gives the sufficient degree of the evidence in information reasoning. Accordingly, the intelligent systems can help the users to solve their problems. This invention can be widely used in the field where the large amount of data helps to solve the problems of the users. The intelligent systems constructed by the method of this invention can discover useful information in the data and use the information to making further analysis and reasoning so that the discovered information reasoning rules can be used to solve the problems of the users.

### BRIEF DESCRIPTION OF THE DRAWINGS

FIG. 1 is the Venn diagram of information;

FIG. 2 is the flow diagram of the method of constructing the intelligent computer system according to an example of this patent;

FIG. 3 is the organization structure diagram of the intelligent computer system according to an example of this patent.

### DETAILED DESCRIPTION

This method can be concretely implemented by making the corresponding software in the computer systems.

In the Following, we Introduce the New Information Theory on which the Present Patent is Based.

The complementary set S̅ of an event S represents the information of the event S.

The information quantity of the event S satisfies the following axioms:
(a) negativity: the information quantity of an event is always nonnegative;
(b) monotonicity: if the probability of the event A is less than that of the event B, then the information quantity of the event A is greater than that of the event B;
(c) additivity: if the event A is independent with the event B, then the information quantity of the event “A and B” is equal to the sum of the information quantity of the event A and the information quantity of the event B.
   We can prove that under the above axioms, the information quantity of the event S is

$$I ( \overline{S} ) = log \frac{1}{p ( S )}$$

where p(S) is the probability of the event S. The more the information of the event is, the larger the information quantity of the event is and the stronger the reasoning potential of the event is.

From the basic information quantities I( S̅₁̅), I( S̅₂̅), I( S̅₁̅∪ S̅₂̅) of two events S₁ and S₂ we can give the derived information quantities I( S̅₁̅∩ S̅₂̅) and I( S̅₂̅\ S̅₁̅) of the events. I( S̅₁̅∩ S̅₂̅) is called the degree of relevance of the events S₁ and S₂; I( S̅₂̅\ S̅₁̅) is called the degree of difference of the event S₂ to the event S₁. The quantity I( S̅₁̅∩ S̅₂̅) is different from the mutual information in the traditional information theory. The mutual information is always nonnegative, while I( S̅₁̅∩ S̅₂̅) may be positive or negative, which reflects the degree of “positive relevance” and “negative relevance” of the events S₁ and S₂. For example, when S₁=wearing eyeglasses, S₂=an intellectual, we have I( S̅₁̅∩ S̅₂̅)>0, S₁ and S₂ are positively related to each other; when S₁=wearing eyeglasses, S₂=a child, we have I( S̅₁̅∩ S̅₂̅)<0, S₁ and S₂ are negatively related to each other; when S₁=holiday, S₂=earthquake, we have I( S̅₁̅∩ S̅₂̅)=0, S₁ is independent with S₂.

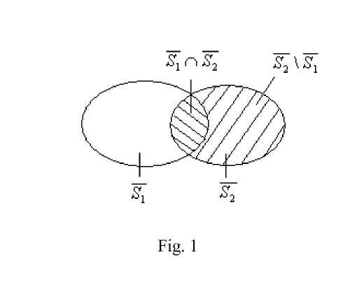

FIG. 1 is the Venn diagram on information. From FIG. 1 we can see all kinds of additive relations among the basic information quantities and the derived information quantities of two events. For instance, we have

$$I ( \overline{{S}_{1}} ⋂ \overline{{S}_{2}} ) = I ( \overline{{S}_{1}} ) + I ( \overline{{S}_{2}} ) - I ( \overline{{S}_{1}} ⋃ \overline{{S}_{2}} ) = log \frac{p ( {S}_{1} , {S}_{2} )}{p ( {S}_{1} ) p ( {S}_{2} )} , \\ I ( \overline{{S}_{2}} \backslash \overline{{S}_{1}} ) = I ( \overline{{S}_{1}} ⋃ \overline{{S}_{2}} ) - I ( \overline{{S}_{1}} ) = log \frac{1}{p ( {S}_{2} \vert {S}_{1} )} , \\ I ( \overline{{S}_{2}} ) = I ( \overline{{S}_{1}} ⋂ \overline{{S}_{2}} ) + I ( \overline{{S}_{2}} \backslash {\overline{S}}_{1} ) ,$$

and so on.

The degree of credibility of the rule S′→S is the ratio of the information quantity of the unknown information of S extracted from the known information of the known evidence S′. In practice, when S′ negatively relates to S, in order to the value of the degree of credibility lies in the interval [−1,0], we use −H(S′→ S̅) (here S̅ is the opposite event of S but not the information of S) as the degree of credibility. That is,

$$H ( {S}^{′} -> S ) = \{ \begin{matrix}\frac{I ( {\overline{S}}^{′} ⋂ \overline{S} )}{I ( \overline{S} )} , & when {S}^{′} is positively related to S \\ 0 , & when {S}^{′} is independent with S \\ - \frac{I ( {\overline{S}}^{′} ⋂ {S}^{\overline{\_}} )}{I ( {S}^{\overline{\_}} )} , & when {S}^{′} is negatively related to S\end{matrix}$$

The degree of credibility reflects not only the relevance but also the actual strength of implication.

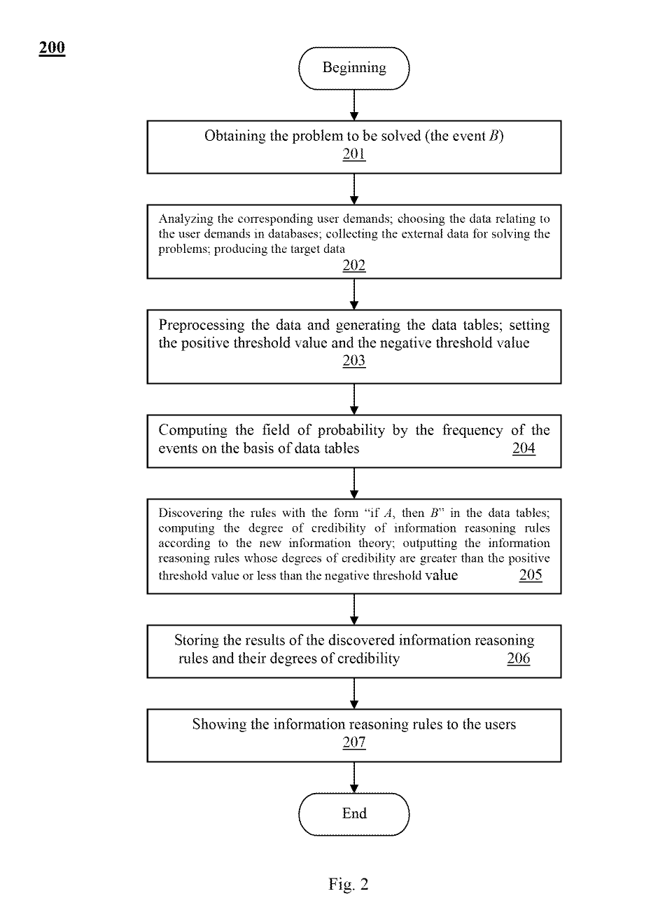

This patent gives a method of constructing the intelligent computer systems based on information reasoning. The hardware of the intelligent system consists of the central processing unit and the data storage unit of the computer system and the core of the method is information reasoning, where the data storage unit stores the databases relating to information reasoning, the data tables generated by choosing target-related data, the field of probability computed from the data tables, the parameters for information reasoning and the obtained information reasoning rules and their degrees of credibility. FIG. 2 is the flow diagram of the method 200 of constructing the intelligent computer system according to an example of this patent, its concrete steps comprising:

In the step S201, obtaining the problem to be solved from the users, that is, obtaining the event B;

In the step S202, analyzing the user demands according the problem; choosing the data relating to the user demands in databases; collecting the external data for solving the problems; producing the target data from the above data;

In the step S203, choosing the data for the computation interactively by the users; producing the data tables by preprocessing the chosen data and setting the adjustable parameters—the positive and the negative threshold value for the degree of credibility by the users;

In the step S204, computing the field of probability from the data table. More concretely, the frequency of an event can be computed from the data table. When the data are sufficient, the frequency is approximately equal to the probability according to the law of large numbers in probability theory. Thus we get the field of probability by computing the frequencies of the events;

In the step S205, discovering the rules like “if A, then B” from the data tables; computing the degree of credibility of information reasoning rules according to the new information theory; obtaining the information reasoning rules whose degrees of credibility are greater than the positive threshold value or less than the negative threshold value;

In the step S206, storing the information reasoning rules and their degrees of credibility, which are obtained in the fifth step;

In the step S207, showing the information reasoning rules obtained in the fifth step interactively to the users and helping the users to valuate the information.

The above third step (i.e., the step S203 in FIG. 2) includes cleaning, integration, transformation, normalization and discretization of data, comprising:

3.1 Data cleaning is to give values to the absent items and processing the inconsistent data;

3.2 Integration and transformation of data are to merge the data in the databases and to transform the data into suitable forms for information reasoning;

3.3, Normalization and discretization of data are to compress the data sets since it is more efficient to implement information reasoning in the processed data sets by using the new information theory.

The concrete method of obtaining the information reasoning rules stated in the fifth step (i.e., the step S205 in FIG. 2) is as follows:

5.1 For the events A and B, obtaining p(A), p(B) and p(A,B) from the field of probability;

5.2 By comparing p(A)p(B) with P(A,B), deciding the relevance between the events A and B:
when p(A,B)>p(A)p(B), A and B are positively related to each other,
when p(A,B)=p(A)p(B), A is independent with B,
when p(A,B)<p(A)p(B), A and B are negatively related to each other;

then computing the degree of credibility H(A→B) of the rule A→B according to the following formula:

$$H ( A -> B ) = \{ \begin{matrix}\frac{log \frac{p ( A , B )}{p ( A ) p ( B )}}{log \frac{1}{p ( B )}} , & when p ( A , B ) > p ( A ) p ( B ) \\ 0 , & when p ( A , B ) = p ( A ) p ( B ) \\ - \frac{log \frac{p ( A , \overline{B} )}{p ( A ) p ( \overline{B} )}}{log \frac{1}{p ( \overline{B} )}} , & when p ( A , B ) < p ( A ) p ( B ) ;\end{matrix}$$

5.3 When the degree of credibility H(A→B) is greater than the positive threshold value or less than the negative threshold value, obtaining the information reasoning rule A→B and outputting the rule “if A, then B” and its degree of credibility H(A→B).

The fifth step is the core of extracting information and implementing information reasoning.

The computation of the degree of credibility under the multi premises is similar, that is, the concrete method of obtaining the information reasoning rules stated in the fifth step (i.e., the step S205 in FIG. 2) is as follows:

5.4 For the events A₁, A₂ . . . Aₙ and B, obtaining p(A₁, A₂, . . . , Aₙ), p(B) and p(A₁, A₂, . . . , Aₙ, B) from the field of probability;

5.5 After comparing p(A₁, A₂, . . . , Aₙ)p(B) with p(A₁, A₂, . . . , Aₙ, B), computing the degree of credibility H(A₁, A₂, . . . , Aₙ→B) of the rule A₁, A₂, . . . , Aₙ→B according to the following formula:

$$H ( {A}_{1} , {A}_{2} , … , {A}_{n} -> B ) = \{ \begin{matrix}\frac{log \frac{p ( {A}_{1} , {A}_{2} , … , {A}_{n} , B )}{p ( {A}_{1} , {A}_{2} , … , {A}_{n} ) p ( B )}}{log \frac{1}{p ( B )}} , & \begin{matrix}when p ( {A}_{1} , {A}_{2} , … , {A}_{n} , B ) > \\ p ( {A}_{1} , {A}_{2} , … , {A}_{n} ) p ( B )\end{matrix} \\ 0 , & \begin{matrix}when p ( {A}_{1} , {A}_{2} , … , {A}_{n} , B ) = \\ p ( {A}_{1} , {A}_{2} , … , {A}_{n} ) p ( B )\end{matrix} \\ - \frac{log \frac{p ( {A}_{1} , {A}_{2} , … , {A}_{n} , \overline{B} )}{p ( {A}_{1} , {A}_{2} , … , {A}_{n} ) p ( \overline{B} )}}{log \frac{1}{p ( \overline{B} )}} , & \begin{matrix}when p ( {A}_{1} , {A}_{2} , … , {A}_{n} , B ) < \\ p ( {A}_{1} , {A}_{2} , … , {A}_{n} ) p ( B ) ;\end{matrix}\end{matrix}$$

5.6 When the degree of credibility H(A₁, A₂, . . . , Aₙ→B) is greater than the positive threshold value or less than the negative threshold value, obtaining the information reasoning rule A₁, A₂, . . . , Aₙ→B and outputting the rule “if A₁, A₂, . . . , Aₙ, then B” and its degree of credibility H(A₁, A₂, . . . , Aₙ→B).

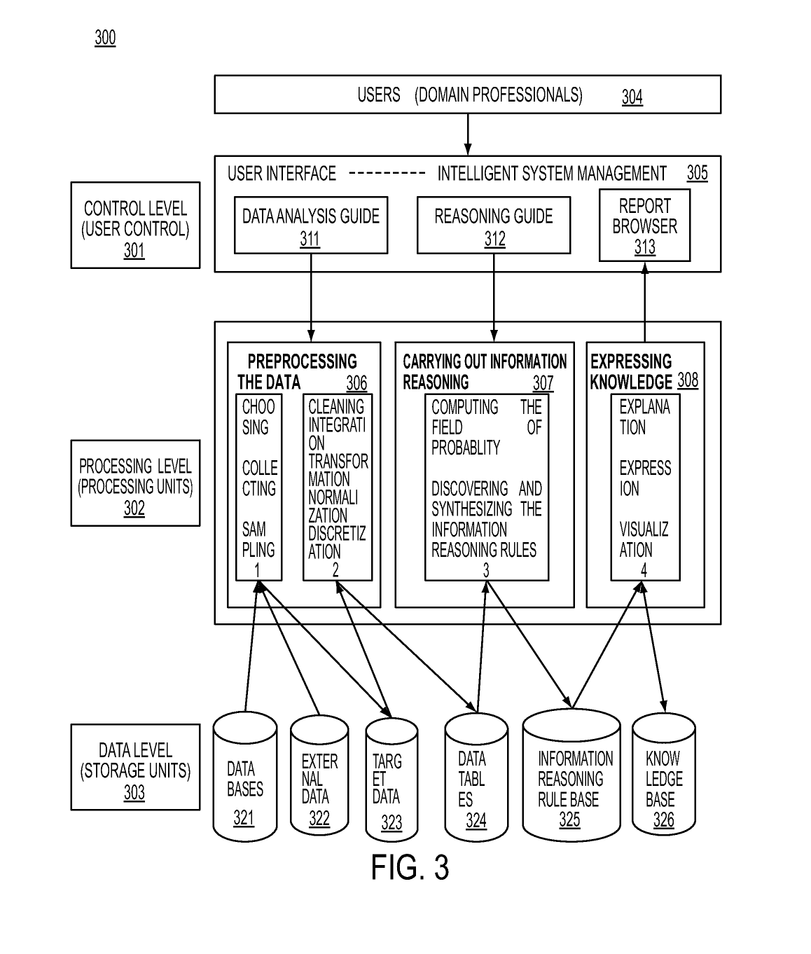

FIG. 3 is the organization structure diagram of the intelligent computer system 300 according to an example of this patent. The intelligent computer system shown by FIG. 3 includes the control level 301, the processing level 302 and the data level 303, where the control level interacts with the users, the processing level can be realized by the processing unit and the data level can be realized by the storage unit. The users (domain professionals) 304 interact with the intelligent system 300 through the user interface 305 of the user level. According to an example of this patent, the user interface 305 includes the data analysis guide 311, the reasoning guide 312 and the report browser 313. The data analysis guide 311 interacts with the preprocessing unit 306 of the processing level, the preprocessing unit 306 implements the tasks of choosing, collecting and sampling data from the databases 321 and the external data 322 (the step 1 in FIG. 3) and produces the target data 323. Furthermore, the preprocessing unit 306 implements cleaning, integration, transformation, normalization and discretization of the target data 323 (the step 2 in FIG. 3) and produces the data tables 324. The reasoning guide 312 interacts with the information reasoning core 307. The information reasoning core 307 computes the field of probability, discovers and synthesizes the information reasoning rules according to the data tables 324 (the step 3 in FIG. 3). The discovered information reasoning rules are stored in the information reasoning rule base 325. The report browser receives the inputs from the knowledge expression unit 308. The knowledge expression unit 308 implements the tasks of explanting, expressing and visualizing the information according to the information reasoning rule base 325 (the step 4 in FIG. 3) so that the report can be shown to the users. The knowledge expression unit 308 stores the knowledge in the knowledge base 326.

### Example 1

In the following, we study an example of computing the degree of credibility by data.

Suppose that there are 1000 students in a school. There are three attributes—sex, grade and health—for each student. The attribute values of sex are male, female; the attribute values of grade are good, fair, poor; the attribute values of health are vigorous, middling, feeble. Putting the students with the same attribute values into a group and recording the number of the students in each group, we have the following data table:

TABLE 1

| | | | | Number |
|---|---|---|---|---|
| Group of | | | | of |
| students | Sex | Grade | Health | students |
| 1 | male | good | vigorous | 20 |
| 2 | male | good | middling | 30 |
| 3 | male | good | feeble | 15 |
| 4 | male | fair | vigorous | 200 |
| 5 | male | fair | middling | 300 |
| 6 | male | fair | feeble | 30 |
| 7 | male | poor | vigorous | 10 |
| 8 | male | poor | middling | 5 |
| 9 | male | poor | feeble | 5 |
| 10 | female | good | vigorous | 10 |
| 11 | female | good | middling | 15 |
| 12 | female | good | feeble | 20 |
| 13 | female | fair | vigorous | 100 |
| 14 | female | fair | middling | 200 |
| 15 | female | fair | feeble | 20 |
| 16 | female | poor | vigorous | 15 |
| 17 | female | poor | middling | 5 |
| 18 | female | poor | feeble | 0 |

According to the above data, we can compute the degree of credibility of the rule “if A, then B”, where A the health of the student is vigorous, B the grade of the student is good (that is the user demand). From the above data table, we have

$$p ( A ) = \frac{20 + 200 + 10 + 10 + 100 + 15}{1000} = \frac{355}{1000} , \\ p ( A , B ) = \frac{20 + 10}{1000} = \frac{30}{1000} , \\ p ( B ) = \frac{20 + 30 + 15 + 10 + 15 + 20}{1000} = \frac{110}{1000} .$$

Since

$$\frac{p ( A , B )}{p ( A ) p ( B )} < 1 ,$$

A and B are negatively related to each other. Therefore, the degree of credibility of the rule “if the health of the student is vigorous, then the grade of the student is good” is as follows:

$$H ( A -> B ) = - \frac{log \frac{p ( A , \overline{B} )}{p ( A ) p ( \overline{B} )}}{log \frac{1}{p ( \overline{B} )}} = - \frac{log \frac{325 \times 1000}{355 \times 890}}{log \frac{1000}{890}} \approx - 0.24 ,$$

That is, the evidence “the health of the student is vigorous” weakly negates the target “then the grade of the student is good”.

By the same method, when computing the degree of the credibility of the rule “if A, then B”, where A=sex is female, B=grade is fair, we have H(A→B)=−0.06. Therefore, A is approximately independent with B. When regarding the rule as an association rule, its confidence is

$$p ( B \vert A ) = \frac{p ( A , B )}{p ( A )} = 0.83 ,$$

which does not reflect that the premise is nearly independent with the conclusion. From here we can see that the method of the present patent is superior when discovering and processing the rules for causal relations.

### Example 2

### Computing the Degree of Credibility Under Multi Premises

For example, we compute the degree of credibility of the rule “if A₁ and A₂, then B”, where A₁=sex is male, A₂=health is vigorous, B=grade is good. From the above data table, we have

$$p ( {A}_{1} , {A}_{2} ) = \frac{20 + 200 + 10}{1000} = \frac{230}{1000} , \\ p ( {A}_{1} , {A}_{2} , B ) = \frac{20}{1000} = \frac{20}{1000} , \\ p ( B ) = \frac{20 + 30 + 15 + 10 + 15 + 20}{1000} = \frac{110}{1000} .$$

Since

$$\frac{p ( {A}_{1} , {A}_{2} , B )}{p ( {A}_{1} , {A}_{2} ) p ( B )} < 1 ,$$

the premises A₁ and A₂ are negatively related to the conclusion B. Therefore, the degree of credibility of the rule “if a student is male and his health is vigorous, then his grade is good” is as follows:

$$H ( {A}_{1} , {A}_{2} -> B ) = - \frac{log \frac{p ( {A}_{1} , {A}_{2} \overline{, B} )}{p ( {A}_{1} , {A}_{2} ) p ( \overline{B} )}}{log \frac{1}{p ( \overline{B} )}} = - \frac{log \frac{210 \times 1000}{230 \times 890}}{log \frac{1000}{890}} \approx - 0.22 ,$$

that is, the premises “the student is male and his health is vigorous” weakly negates the conclusion “his grade is good”.

Here, the so-called rule should reflect the relation between the event A and the event B. More precisely, the information reasoning rule “if A, then B” with the degree of credibility H(A→B) reflects the relation between the events A and B. The degree of credibility is different from the confidence of the association rule since the degree of credibility may be positive or negative. This patent gives a method to discover the useful and strong positive information reasoning rules and negative information reasoning rules. Here that a rule is strong refers to that the absolute value of the degree of credibility of the rule is large. The stronger a rule “if A, then B” is, the larger the actual strength of the implication is. In practice, the positive threshold value and the negative threshold value are set for the degree of credibility. When the degree of credibility of a rule is greater than the positive threshold value or less than the negative threshold value, it is a strong information reasoning rule. Two extreme cases are as follows: if H(A→B)=1, then the rule “if A, then B” holds with the probability 1; if H(A→B)=−1, then the rule “if A, then not B” holds with the probability 1.

### Example 3

### Applications in Geochemical Prospecting

When prospecting the gold mines in some region, the practical investigation is implemented at the chosen spots according to the geochemical theory. The gold mines are found in some of the spots.

For the example of prospecting the gold mines, the steps of concrete implementation are as follows:

The first step: the users are exploration staffs and their problem is how to decide whether there is a gold mine at a spot which is not practically investigated according to the results of investigated spots. Here, the target event B is “there is a gold mine in the spot”.

The second step: we have the database which contains the data of the content of elements of the samples collected at the surface of the region. A sample is collected every 4 square kilometers. The content of more than 30 kinds of elements such as gold, silver, lead, zinc is analyzed for each sample. The form of the data table in the database is as follows (only ten elements are listed):

| Horizontal | | | | | | | | | | | |
|---|---|---|---|---|---|---|---|---|---|---|---|
| scale | Ordinate | Ag | Au | CaO | Cu | Fe2O3 | Li | Mn | Ni | Pb | Zn |
| 587 | 4431 | 50 | 1.8 | 2.28 | 21 | 5.58 | 62 | 650 | 31 | 22 | 116 |
| 589 | 4431 | 50 | 1.2 | 1.73 | 24 | 5.95 | 43 | 750 | 27 | 22 | 121 |
| 591 | 4431 | 70 | 2.1 | 1.8 | 25 | 5.75 | 53 | 750 | 28 | 25 | 121 |
| 593 | 4431 | 10 | 1.6 | 1.28 | 25 | 5.85 | 53 | 700 | 32 | 22 | 117 |
| 595 | 4431 | 50 | 1.4 | 1.5 | 19 | 4.65 | 37 | 650 | 28 | 19 | 108 |
| 597 | 4431 | 40 | 2.0 | 3.55 | 23 | 5.28 | 58 | 650 | 30 | 20 | 114 |
| 599 | 4431 | 60 | 1.6 | 4.83 | 20 | 4.17 | 58 | 650 | 24 | 19 | 50 |
| 601 | 4431 | 50 | 1.4 | 2.1 | 18 | 4.55 | 47 | 625 | 22 | 20 | 113 |
| 603 | 4431 | 50 | 1.2 | 1.4 | 20 | 4.65 | 47 | 750 | 26 | 19 | 93 |
| 605 | 4431 | 50 | 0.7 | 2.4 | 26 | 5.7 | 72 | 700 | 32 | 20 | 130 |

In information reasoning, we do not need to consider the horizontal scales and the ordinates. According to the professional knowledge of the users, some elements have no relation with the gold mine. Therefore, when constructing the intelligent system, we discard the horizontal scales, the ordinates and the above elements which are irrelevant with the gold mine. The data of the remained elements are used to implement information reasoning in the intelligent system. The results of the investigated spots are the external data. Summing up all of the above data, we get the target data (the step 1 in the FIG. 3). For this example, the target data are as follows:

| | | | | | | | | | | Gold |
|---|---|---|---|---|---|---|---|---|---|---|
| Ag | Au | CaO | Cu | Fe2O3 | Li | Mn | Ni | Pb | Zn | mine |
| 50 | 1.8 | 2.28 | 21 | 5.58 | 62 | 650 | 31 | 22 | 116 | 0 |
| 50 | 1.2 | 1.73 | 24 | 5.95 | 43 | 750 | 27 | 22 | 121 | 0 |
| 70 | 2.1 | 1.8 | 25 | 5.75 | 53 | 750 | 28 | 25 | 121 | 0 |
| 10 | 1.6 | 1.28 | 25 | 5.85 | 53 | 700 | 32 | 22 | 117 | 0 |
| 50 | 1.4 | 1.5 | 19 | 4.65 | 37 | 650 | 28 | 19 | 108 | 0 |
| 40 | 2.0 | 3.55 | 23 | 5.28 | 58 | 650 | 30 | 20 | 114 | 0 |
| 60 | 1.6 | 4.83 | 20 | 4.17 | 58 | 650 | 24 | 19 | 50 | 0 |
| 50 | 1.4 | 2.1 | 18 | 4.55 | 47 | 625 | 22 | 20 | 113 | 0 |
| 50 | 1.2 | 1.4 | 20 | 4.65 | 47 | 750 | 26 | 19 | 93 | 0 |
| 50 | 0.7 | 2.4 | 26 | 5.7 | 72 | 700 | 32 | 20 | 130 | 0 |

where the attribute value of the attribute “gold mine” is 0 when there is no gold mine and 1 when there is a gold mine.

The third step: according to the need of the users, choosing the data for the computation interactively by the users. In this example, the users choose all the target data. After preprocessing the chosen data, we get a data table (the step 2 in the FIG. 3). The data table is as follows:

| | | | | | | | | | | Gold |
|---|---|---|---|---|---|---|---|---|---|---|
| Ag | Au | CaO | Cu | Fe2O3 | Li | Mn | Ni | Pb | Zn | mine |
| 1 | 2 | 2 | 1 | 1 | 4 | 1 | 1 | 3 | 3 | 0 |
| 1 | 2 | 1 | 1 | 1 | 3 | 1 | 1 | 3 | 3 | 0 |
| 1 | 3 | 1 | 1 | 1 | 4 | 1 | 1 | 3 | 3 | 0 |
| 0 | 2 | 0 | 1 | 1 | 4 | 1 | 1 | 3 | 3 | 0 |
| 1 | 2 | 2 | 1 | 1 | 2 | 1 | 1 | 2 | 3 | 0 |
| 1 | 3 | 3 | 1 | 1 | 4 | 1 | 1 | 2 | 3 | 0 |
| 1 | 2 | 4 | 1 | 0 | 4 | 1 | 1 | 2 | 0 | 0 |
| 1 | 2 | 2 | 1 | 1 | 3 | 0 | 1 | 2 | 3 | 0 |
| 1 | 2 | 1 | 1 | 1 | 3 | 1 | 1 | 2 | 2 | 0 |
| 1 | 1 | 2 | 2 | 1 | 5 | 1 | 1 | 2 | 4 | 0 |

The users set the adjustable parameters: the positive and the negative threshold value for the degree of credibility. In this example, the positive threshold value is set to be 0.75, the negative threshold value is set to be −0.65.

The fourth step: computing the field of probability from the data table. More concretely, the frequency of an event can be computed from the data table. When the data are sufficient, the frequency is approximately equal to the probability according to the law of large numbers in probability theory. Thus we get the field of probability by computing the frequencies of the events.

The fifth step: for this example, the key for solving the problem is to discover the rules which reflect the causal relations among the content of elements and the gold mine. Base on the rules, the users can decide whether there is a gold mine at the uninvestigated spots. Here we want to find the rules whose conclusion B is “there is a gold mine” and whose premises are the content of elements. These rules reflect the causal relations from the premises to the conclusion. Concretely speaking, the intelligent system discovers the rules like “if A₁, A₂, . . . , Aₙ, then B” from the data tables and computes the degree of credibility of the reasoning rule A₁, A₂, . . . , Aₙ→B. In this example, the degrees of credibility of all reasoning rules like A₁, A₂, . . . , Aₙ→B are computed for n being 1 or 2. And an information reasoning rule is obtained when its degree of credibility is greater than the positive threshold value or less than the negative threshold value. When n is greater than 2, we only consider the rules which is obtained by adding new premises on the basis of discovered information reasoning rules (the step 3 of FIG. 3). For example, the degree of credibility of the rule “if the attribute value of Fe2O3 is 4 and the attribute value of CaO is 1, then there is a gold mine” is −93%. The negative degree of credibility shows that the premises are negatively related to the conclusion. Since the degree of credibility is less than the negative threshold value, this rule is a strong negative information reasoning rule.

The sixth step: storing the information reasoning rules and their degrees of credibility obtained in the fifth step;

The seventh step: explaining the information reasoning rules stored in the sixth step. For example, the rule is “if the attribute value of Fe2O3 is 4 and the attribute value of CaO is 1, then there is a gold mine” and its degree of credibility is −93%. Actually, the rule is “if the content of Fe2O3 is between 9.5 and 12, the content of CaO is between 1.4 and 2, then there is a gold mine”, its degree of credibility is −93%. The intelligent system sums up all of results and produce the report for the users. The information extracted by information reasoning are interactively shown to the users and the system helps the users to valuate the information.

The discovered information reasoning rules reflect the causal relations between the premises and the conclusion (“there is a gold mine”) and their degrees of credibility reflects the actual strength of the implication rules from the premises to the conclusion. The users (the exploration staffs) can use the information extracted from the data by information reasoning to decide whether there is a gold mine at the uninvestigated spots. For this example, the technical scheme of this patent is superior to the traditional ones when discovering the causal relations. The information extracted by using information reasoning is helpful for the research of geochemistry.

What is claimed is:

1. A method of constructing the intelligent computer systems based on information reasoning, the hardware of the intelligent system consists of the central processing unit and the data storage unit of the computer system and the core of the method is information reasoning, where the data storage unit stores the databases relating to information reasoning, the data tables generated by choosing target-related data, the field of probability computed from the data tables, the parameters for information reasoning and the obtained information reasoning rules and their degrees of credibility. The method comprising the steps of:
the first step: obtaining the problem to be solved from the users, that is, obtaining the event B;
the second step: analyzing the user demands according the problem; choosing the data relating to the user demands in databases; collecting the external data for solving the problems;
producing the target data from the above data;
the third step: choosing the data for the computation interactively by the users; producing the data tables by preprocessing the chosen data and setting the adjustable parameters—the positive and the negative threshold value for the degree of credibility by the users;
the fourth step, computing the field of probability from the data table. More concretely, the frequency of an event can be computed from the data table. We regarded the frequency of an event as its probability, thus we get the field of probability by computing the frequencies of the events;
the fifth step, discovering the rules like “if A, then B” from the data tables; computing the degree of credibility of information reasoning rules according to the new information theory; obtaining the information reasoning rules whose degrees of credibility are greater than the positive threshold value or less than the negative threshold value. In the new information theory, the degree of relevance between two events A and B may be positive or negative, which reflects the degree of positive relevance or negative relevance between the events A and B. Based on this fact, we can compute the degree of credibility, which measures the actual strength of the implication from the premise A to the conclusion B;
the sixth step: storing the information reasoning rules and their degrees of credibility, which are obtained in the fifth step;
the seventh step: showing the information reasoning rules obtained in the fifth step interactively to the users and helping the users to valuate the information.

2. According to the method described in the claim 1, the feature lies in the preprocessing of the third step, which includes cleaning, integration, transformation, normalization and discretization of data, comprising:
3.1 Data cleaning is to give values to the absent items and processing the inconsistent data;
3.2 Integration and transformation of data are to merge the data in the databases and to transform the data into suitable forms for information reasoning;
3.3, Normalization and discretization of data are to compress the data sets since it is more efficient to implement information reasoning in the processed data sets by using the new information theory.

3. According to the method described in the claim 1, the feature lies in the concrete method of discovering the rule like “if A, then B” from the data tables, comprising:
5.1 For the events A and B, obtaining p(A), p(B) and p(A,B) from the field of probability;
5.2 By comparing p(A)p(B) with P(A,B), deciding the relevance between the events A and B:
when p(A,B)>p(A)p(B), A and B are positively related to each other,
when p(A,B)=p(A)p(B), A is independent with B,
when p(A,B)<p(A)p(B), A and B are negatively related to each other;
then computing the degree of credibility H(A→B) of the rule A→B according to the following formula.
$$H ( A -> B ) = \{ \begin{matrix}\frac{log \frac{p ( A , B )}{p ( A ) p ( B )}}{log \frac{1}{p ( B )}} , & when p ( A , B ) > p ( A ) p ( B ) \\ 0 , & when p ( A , B ) = p ( A ) p ( B ) \\ - \frac{log \frac{p ( A , \overline{B} )}{p ( A ) p ( \overline{B} )}}{log \frac{1}{p ( \overline{B} )}} , & when p ( A , B ) < p ( A ) p ( B ) ;\end{matrix}$$
5.3 When the degree of credibility H(A→B) is greater than the positive threshold value or less than the negative threshold value, obtaining the information reasoning rule A→B and outputting the rule “if A, then B” and its degree of credibility H(A→B).

4. According to the method described in the claim 1, the feature lies in the computation of the degree of credibility under multi premises, the fifth step further comprising:
5.4 For the events A₁, A₂, . . . , Aₙ and B, obtaining p(A₁, A₂, . . . , Aₙ), p(B) and p(A₁, A₂, . . . , Aₙ, B) from the field of probability;
5.5 After comparing p(A₁, A₂, . . . , Aₙ)p(B) with p(A₁, A₂, . . . , Aₙ, B), computing the degree of credibility H(A₁, A₂, . . . , Aₙ →B) of the rule A₁, A₂, . . . , Aₙ→B according to the following formula:
$$H ( {A}_{1} , {A}_{2} , … , {A}_{n} -> B ) = \{ \begin{matrix}\frac{log \frac{p ( {A}_{1} , {A}_{2} , … , {A}_{n} , B )}{p ( {A}_{1} , {A}_{2} , … , {A}_{n} ) p ( B )}}{log \frac{1}{p ( B )}} , & \begin{matrix}when p ( {A}_{1} , {A}_{2} , … , {A}_{n} , B ) > \\ p ( {A}_{1} , {A}_{2} , … , {A}_{n} ) p ( B )\end{matrix} \\ 0 , & \begin{matrix}when p ( {A}_{1} , {A}_{2} , … , {A}_{n} , B ) = \\ p ( {A}_{1} , {A}_{2} , … , {A}_{n} ) p ( B )\end{matrix} \\ - \frac{log \frac{p ( {A}_{1} , {A}_{2} , … , {A}_{n} , \overline{B} )}{p ( {A}_{1} , {A}_{2} , … , {A}_{n} ) p ( \overline{B} )}}{log \frac{1}{p ( \overline{B} )}} , & \begin{matrix}when p ( {A}_{1} , {A}_{2} , … , {A}_{n} , B ) < \\ p ( {A}_{1} , {A}_{2} , … , {A}_{n} ) p ( B ) ;\end{matrix}\end{matrix}$$
5.6 When the degree of credibility H(A₁, A₂, . . . , Aₙ→B) is greater than the positive threshold value or less than the negative threshold value, obtaining the information reasoning rule A₁, A₂, . . . , Aₙ→B and outputting the rule “if A₁, A₂, . . . , Aₙ, then B” and its degree of credibility H(A₁, A₂, . . . , Aₙ→B).
